(19) United States
(12) Patent Application Publication
(10) Pub. No.: US 2011/0006518 A1
(43) Pub. Date: Jan. 13, 2011

(54) Compression Seal

(76) Inventor: Adrian Roger Poulton, West Midlands (GB)

Correspondence Address: CLARK HILL PLC, 150 NORTH MICHIGAN AVENUE, SUITE 2700, CHICAGO, IL, 60601, US

(21) Appl. No.: 12/833,506

(22) Filed: Jul. 9, 2010

(30) Foreign Application Priority Data
Jul. 10, 2009 (GB) 0912063.5
Jan. 12, 2010 (GB) 1000441.4

(51) Int. Cl. F16L 19/00; F16L 21/00

(52) U.S. Cl. 285/355; 277/626; 285/335; 285/370

(57) ABSTRACT

A compression seal, for a conduit fitting comprising a body and an insert, is disclosed. The compression seal comprises an annular trunk having a first end, a second end and an outwardly bulbous section therebetween. A sealing surface is provided on an outer portion of the bulbous section and a resiliently deformable element is provided at or adjacent the first end of the trunk. An assembly comprising a first conduit, a second conduit and a fitting including a compression seal as described above, is also disclosed.

### FIELD OF THE INVENTION

This invention relates to a compression seal. Particularly, but not exclusively, the invention relates to a compression seal for use in a compression fitting for a plastic coated metal conduit requiring electrical continuity.

This document claims priority from UK patent applications GB0912063.5 and GB 1000441.4—the content of which are hereby incorporated by reference.

### BACKGROUND TO THE INVENTION

A compression seal is typically used in a fitting (e.g. a connector or cable gland) for a conduit in the form of a pipe, tube, hose, cable or similar element, where that element passes from one environment to another. It will be noted that the conduit could be configured for the passage of a fluid (e.g. in the form of a liquid or gas) or a solid (e.g. in the form of a powder), or it may be configured for the transportation of electricity. The fitting may therefore serve to prevent leakage of a fluid or solid flowing through the element and/or it may serve to prevent ingress of an external fluid (e.g. water or air) into the element. It may also serve to electrically connect or isolate one part of the element/fitting from another part of the element/fitting and it may prevent movement of the element due to a pressure differential.

A particular characteristic of a compression seal fitting is that it employs mechanical components to exert an axial force on a deformable seal such that it flexes to form an impervious boundary between the fitting and the element. Typically, the seal itself would be made from plastic. However, in certain environments (such as those exposed to high temperatures or hazardous environments) plastic is not suitable for use in the fitting. The use of deformable metal seals has therefore been proposed but this has presented two significant problems. The first problem is that, if the fitting is used to connect to a plastic coated conduit, the edge of the metal seal tends to cut into and damage the plastic when the seal is compressed. The second problem is that the tolerance between the seal and the fitting becomes critical since there is much less ‘give’ in a metal-to-metal contact than there is in a plastic-to-metal contact and, if the contact between the parts is not sufficient, leakage could occur and/or electrical conductivity could be lost.

More specifically, when the fitting is employed with a plastic coated metal conduit requiring electrical continuity, a metal insert is provided that screws onto the end of the conduit and is forced by the seal into contact with the fitting body to thereby ensure electrical continuity therethrough. However, if the compression seal and/or insert are slightly larger than required (due manufacturing tolerances) the seal will contact the insert and force it into contact with the body of the fitting before the seal contacts the body of the fitting to provide the required seal with the fitting body to prevent water from entering the conduit. Conversely, if the seal and/or insert are slightly smaller than required (due manufacturing tolerances) the seal will contact the fitting body to form the required seal before contacting the insert to force it into contact with the body to provide the required electrical continuity. In either case, the metal seal will be unable to form the two functions it is designed to serve and the fitting will fail.

It is therefore an aim of the present invention to provide a compression seal that addresses the above-mentioned problems.

### SUMMARY OF THE INVENTION

According to a first aspect of the present invention there is provided a compression seal for a conduit fitting comprising a body and an insert, the compression seal comprising an annular trunk having a first end, a second end and an outwardly bulbous section therebetween; a sealing surface is provided on an outer portion of said bulbous section; and wherein a resiliently deformable element is provided at or adjacent the first end of the trunk.

In embodiments of the invention, the resiliently deformable element will act as a spring such that, in use, the resiliently deformable element will be arranged to take up manufacturing tolerances by compressing and, at the same time, exerting an axial restoring force to urge the insert against the body of the fitting when the sealing surface is in sealing contact with the body of the fitting.

The above aspect of the present invention therefore provides for a reliable compression seal since it is significantly less reliant on manufacturing tolerances than current seals, in order to ensure the required sealing function as well as the required forced contact with the insert. It will be understood that this second function is achieved by calculating an acceptable predetermined range of compression (based on the manufacturing tolerances of each cooperating part of the fitting) to ensure that there is always adequate contact between the insert and the seal even if both components are of the minimum likely dimension due to manufacturing tolerances.

It will be understood that the mating of the seal with the body is required in order to ensure there are no gaps through which fluids or solids can leak (or be introduced). Where the seal is used in a fitting for a plastic coated conduit requiring electrical continuity, it is necessary for the compression seal to transmit axial force to the insert to ensure that the insert abuts the body of the fitting to thereby provide electrical continuity between the conduit and the body, via the insert.

Advantageously, the resiliently deformable element may restore to its uncompressed state after use and, as such, it may be possible to re-use the seal. Thus, the seal may be configured for single or multiple uses.

It will be noted that embodiments of the present invention not only require a high level of compressible strength (to withstand compression during use) but also a relatively high level of tensile strength since the seal must be capable of resisting fracture or other damage if the conduit is inadvertently pulled outwardly of the fitting, when in use.

The design of the present invention is not only effective when made from plastic but it is also particularly effective when made from other materials such as metal, which are harder and less able to take up manufacturing tolerances through natural distortion.

In one embodiment, the compression seal is formed from brass. The compression seal may be formed from metal that has been annealed.

In a particular embodiment, the resiliently deformable element comprises one or more slots or holes provided adjacent the first end of the trunk. The slots may be fully enclosed by the material of the resiliently deformable element or they may have an open end at the first end of the trunk. The slots may be part-annular or they may extend generally in an axial direction. The slots may extend perpendicularly to the first end or they may be sloped thereto. In certain embodiments, the slots may be V-shaped or U-shaped. Two or more part-annular slots may be provided at the same axial position so as to form a discontinuous ring of slots around the trunk. Two or more discontinuous rings of slots may be provided, each spaced axially from the other. In one embodiment, each discontinuous ring of slots is arranged such that only a portion of each slot is axially aligned with a portion of an adjacent slot. In other words, each slot is arranged to axially overlap with a slot in an adjacent ring of slots. This arrangement is advantageous in providing a sufficient range of compression whilst maintaining a desired degree of resilient strength to restore the seal to its uncompressed state.

In an alternative embodiment, a spiral slot may be provided adjacent the first end of the trunk.

It will be understood that the slots in the above embodiments allow the seal to compress axially by flexing of the material surrounding the slots into the spaces provided by the slots. The material between the slots provides the restoring force to urge the seal back to its uncompressed state.

The second end of the trunk may be formed into a collar extending in an axial direction. An advantage of such a collar is that, when a compression nut is applied to the fitting in use, the inner surface of the nut will apply a radial force to the second end and the collar will dissipate the radial force along a conduit held therein rather than simply transmitting the radial force to the conduit in a concentrated manner via the second end. Accordingly, the collar serves to prevent the second end from being forced directly into the conduit and causing damage thereto.

An annular channel may be provided in the inner surface of the compression seal, radially opposite to the outwardly bulbous section. Thus, the inner surface of the outwardly bulbous section may effectively be hollowed out. This structure helps to ensure that the first and second ends of the trunk can flex in use to effect the required contact and sealing characteristics. Alternatively, the bulbous section may be solid.

The bulbous section may be substantially in the form of a half hexagon when viewed in cross-section. This shape is advantageously strong and particularly suitable for transmitting an effective sealing force through the sealing surface, which may be provided on a sloped side of the half hexagon closest to the first end.

According to a second aspect of the present invention there is provided a fitting comprising a body, an insert and a compression seal in accordance with the first aspect of the invention.

The body may comprise a first hollow cylinder having a first diameter and a second hollow cylinder having a second diameter, the first and second diameters being different such that a radial flange is provided therebetween. The first and second hollow cylinders may be threaded on at least part of their respective outer surfaces.

The insert may comprise a radially flat annular base sized to fit within one of the first or second cylinders of the body and to abut the radial flange thereof. A hollow outer cylindrical shaft may extend from the outer circumference of the base. The outer cylindrical shaft may comprise an axially aligned ribbed outer surface. In the above described embodiments, it will be understood that the free end of the outer cylindrical shaft will be arranged to mate with the first end of the compression seal, when in use.

A hollow inner cylindrical shaft may extend from the inner circumference of the base in the same direction as the outer cylindrical shaft. A single spiral projection may be provided on the outer surface of the inner cylindrical shaft, towards the free end thereof. In use, the spiral projection will be arranged to locate on an inner surface of a conduit applied to the fitting, to retain the conduit and ensure good electrical continuity between the conduit and the insert.

The insert may be formed from metal and may be un-annealed.

The fitting may further comprise a compression nut. The compression nut may be configured for screw-fit engagement with the larger of the first or second cylinders of the body. The end of the compression nut furthest from the body, when in use, may be provided with an inwardly extending radial lip.

It will be understood that, in use, the insert will be placed in the body with its annular base adjacent the radial flange of the body. The first end of the compression seal will then be placed into the body such that the resiliently deformable element is located adjacent the outer cylindrical shaft of the insert and the sealing surface of the compression seal is adjacent the free end of the body. The compression nut will then be positioned over the bulbous section of the compression seal and screwed onto the body. Upon tightening of the nut, the lip will apply an axial force to the compression seal to urge the sealing surface into contact with the free end of the body and at the same time force the resiliently deformable element to compress. This in turn will generate a restoring force which will urge the insert against the radial flange of the body to secure it thereto. In addition, the lip with apply a radial force to the collar of the compression seal.

According to a third aspect of the present invention there is provided an assembly comprising a first conduit, a second conduit and a fitting therebetween in accordance with the second aspect of the invention.

The first and/or second conduits may be made from metal and/or plastics material.

In a particular embodiment, the first and second conduits are electrically conductive. In which case, the first and/or second conduit may comprise an electrically conductive element embedded in a sheath of hollow cylindrical plastics material. In use, the inner cylindrical shaft of the insert is configured to locate against the inner surface of the plastics sheath such that the end of the first or second conduit (and the electrical contact therein) abuts the annular base of the insert. As described above in relation to the fitting, tightening of the compression nut will force the compression seal into contact with the insert and this will urge the insert into contact with the radial flange of the body thereby ensuring good electrical continuity between the insert and the body.

### BRIEF DESCRIPTION OF THE DRAWINGS

Certain embodiments of the present invention are described below in relation to the accompanying drawings, in which:

FIG. 1 shows an enlarged perspective view of a compression seal according to an embodiment of the present invention;

FIG. 2 shows a longitudinal cross-sectional view of an upper half of a fitting body for use in a fitting employing the compression seal of FIG. 1;

FIG. 3 shows a longitudinal cross-sectional view of an upper half of an insert for use in a fitting employing the compression seal of FIG. 1;

FIG. 4 shows a longitudinal cross-sectional view of an upper half of the compression seal shown in FIG. 1;

FIG. 5 shows a longitudinal cross-sectional view of an upper half of a compression nut for use in a fitting employing the compression seal of FIG. 1;

FIG. 6 shows a longitudinal cross-sectional view of an upper half of a fitting including the fitting body of FIG. 2, the insert of FIG. 3 and the compression nut of FIG. 5, employing a conventional compression seal, with a plastic coated metal conduit (requiring electrical continuity) placed in the fitting and the compression nut tightened;

FIG. 7A shows a view similar to that of FIG. 6 wherein the conventional compression seal has been replaced by the compression seal of FIGS. 1 and 4 and the compression nut has yet to be tightened;

FIG. 7B shows a view similar to that of FIG. 7A after the compression nut has been tightened;

FIGS. 8A through 8E show side views of various compression seals according to further embodiments of the invention, each comprising a different resiliently deformable element;

More specifically, FIG. 8A shows a seal having a resiliently deformable element comprising a series of axially extending V-shaped slots;

FIG. 8B shows a seal having a resiliently deformable element comprising a series of sloped slots extending from the first end of the trunk to the edge of the bulbous section;

FIG. 8C shows a seal having a resiliently deformable element comprising a series of circular holes disposed in three axially spaced rings;

FIG. 8D shows a seal having a resiliently deformable element comprising a series of slots extending perpendicularly from the first end of the trunk and terminating part-way towards the edge of the bulbous section; and

FIG. 8E shows a seal having a resiliently deformable element comprising a series of sloped slots extending from the first end of the trunk and terminating part-way towards the edge of the bulbous section.

### DETAILED DESCRIPTION OF CERTAIN EMBODIMENTS

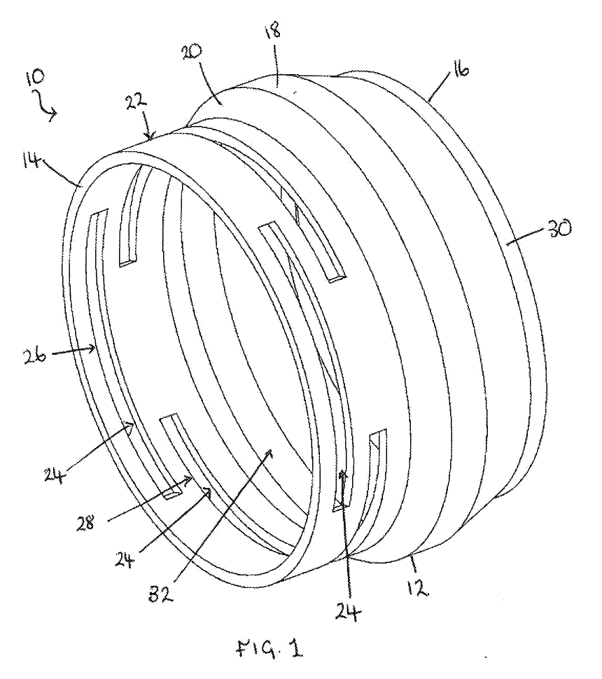

With reference to FIG. 1, there is illustrated a compression seal 10 according to an embodiment of the present invention. The compression seal 10 comprises an annular annealed brass trunk 12 having a first end 14, a second end 16 and an outwardly bulbous section 18 therebetween. A sealing surface 20 is provided on an outer portion of the bulbous section 18. A resiliently deformable element 22 is provided adjacent the first end 14 of the trunk 12. In this particular embodiment, the resiliently deformable element 22 comprises four part-annular slots 24. The two of the part-annular slots 24 are provided at a first axial position, adjacent the first end 14, so as to form a first discontinuous ring 26 of slots 24 around the trunk 12. The other two of the part-annular slots 24 are provided at a second axial position, adjacent first ring 26, so as to form a second discontinuous ring 28 of slots 24 around the trunk 12. As illustrated, the first and second rings 26, 28 of slots 24 are rotationally offset such that each slot 24 in each ring 26, 28 axially overlaps with a portion of each of the slots in the adjacent ring 26, 28.

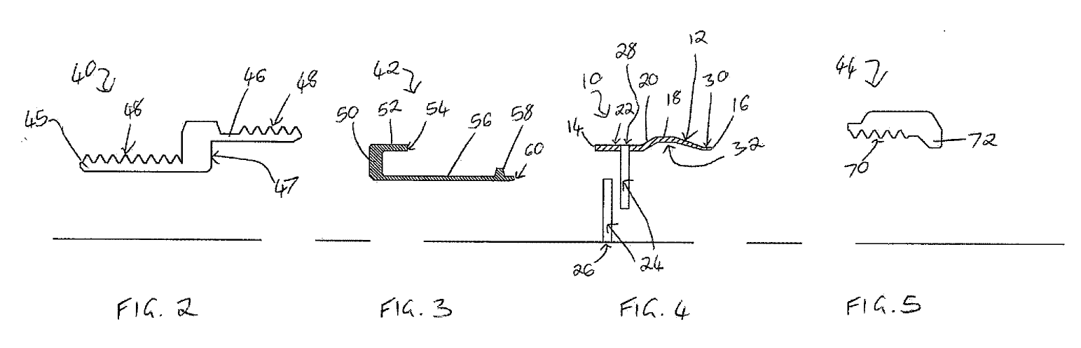

The second end 16 of the trunk 12 is formed into a collar 30 extending in an axial direction. An annular channel 32 is provided in the inner surface of the compression seal 10, radially opposite to the outwardly bulbous section 18. As best illustrated in FIG. 4, the bulbous section 18 is substantially in the form of a half hexagon when viewed in cross-section and the sealing surface 20 is provided on a sloped side of the half hexagon closest to the first end 16.

FIGS. 2, 3, 4 and 5 illustrate, respectively, the individual components of a fitting body 40, a conduit insert 42, the compression seal 10 described above, and a compression nut 44 for use in a fitting in accordance with an embodiment of the present invention, as will be described below. Although only cross-sectional views of the upper halves of the components are illustrated in FIGS. 2 through 7B, it will be understood that each of the components are symmetrical about a longitudinal axis such that the lower halves are configured as mirror images of the upper halves.

The fitting body 40 of FIG. 2 comprises a first hollow cylinder 45 having a first diameter and a second hollow cylinder 46 having a second diameter. In this particular embodiment, the first diameter is less than the second diameter and a radial flange 47 is therefore provided between the first and second cylinders, forming a ledge at the base of the second cylinder 46. Each of the first and second cylinders 45, 46 are provided with a threaded portion 48 on their respective outer surfaces.

As shown in FIG. 3, the insert 42 is made from un-annealed brass and comprises a radially flat annular base 50 sized to fit within the second cylinder 46 so that it can abut the radial flange 47. A hollow outer cylindrical shaft 52 extends from the outer circumference of the base 50. The outer cylindrical shaft 52 comprises an axially aligned ribbed outer surface (not shown). A free end 54 of the outer cylindrical shaft 52 is arranged to mate with the first end 14 of the compression seal 10, as will be described below.

A hollow inner cylindrical shaft 56 extends from the inner circumference of the base 50, in the same direction as the outer cylindrical shaft 52. A single spiral projection 58 is provided on the outer surface of the inner cylindrical shaft 56, towards a free end 60 thereof.

FIG. 4 shows a cross-sectional view of an upper half of the compression seal 10 illustrated in FIG. 1. This view best illustrates the annular channel 32 provided in the inner surface of the compression seal 10, radially opposite to the outwardly bulbous section 18.

As shown in FIG. 5, the compression nut 44 is provided with an internal screw-thread 70 configured for screw-fit engagement with the threaded portion 48 on the outer surface of the second cylinder 46 of the body 40. The end of the compression nut 44 furthest from the body 40, when in use, is provided with an inwardly extending radial lip 72.

FIG. 6 shows a longitudinal cross-sectional view of an upper half of a fitting 78 including the fitting body 40 of FIG. 2, the insert 42 of FIG. 3 and the compression nut 44 of FIG. 5, with a conventional compression seal 80, and with a plastic coated metal conduit 82 (requiring electrical continuity) placed in the fitting 78 and the compression nut 44 tightened. The conventional compression seal 80 is similar to the compression seal 10 according to the present invention except that it does not include a resiliently deformable element 22, a collar 30 or a hollowed-out annular channel 32. Like reference numerals are therefore used to indicate only the trunk 12, the first end 14, the second end 16, the bulbous section 18 and the sealing surface 20.

The conduit 82 comprises a spiral-wound flexible metal tube 84 within a tubular plastic sheath 86. In use, the inner cylindrical shaft 56 of the insert 42 is configured to screw into the metal tube 84 until the end of the tube 84 abuts the annular base 50 of the insert 42. Tightening of the compression nut 44 brings the lip 72 into contact with the bulbous section 18 and thereby forces the sealing surface 20 of the compression seal 80 into contact with end of the fitting body 40. If the components are all accurately sized, the first end 14 of the seal 80 will, at the same time as the sealing surface 20 contacts the body 40, contact the insert 42 to urge it into contact with the radial flange 47 of the body 40 thereby maintaining electrical continuity. However, if any of the body 40, the insert 42 or seal 80 are incorrectly sized (e.g. due to manufacturing tolerances) it may not be possible for the seal 80 to form a contact at the sealing surface 20 and at the first end 14 at the same time. Accordingly, the fitting 78 may either be inadequately sealed or it may include an inadequate electrical continuity.

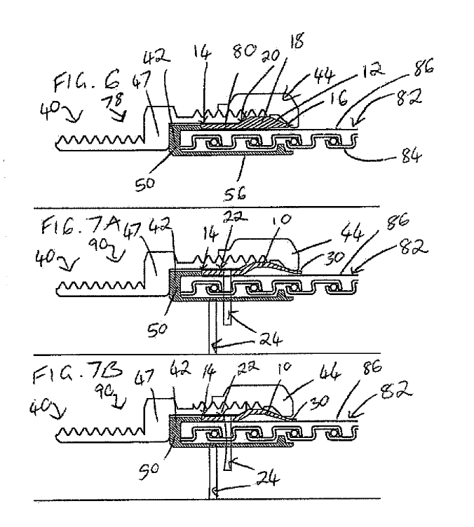

FIGS. 7A and 7B illustrate a fitting 90, according to an embodiment of the invention, which is similar to that of FIG. 6 but wherein the conventional compression seal 80 has been replaced by the compression seal 10 of FIGS. 1 and 4. More specifically, FIG. 7A shows the fitting 90 prior to the compression nut 44 being tightened and FIG. 7B shows the fitting 90 after the compression nut 44 has been tightened. It will be noted that the fitting 90 is capable of providing an electrical and fluid-tight connection between a conduit and a device, enclosure or other conduit (not shown).

As described above, the insert 42 is placed in the body 40 with its annular base 50 adjacent the radial flange 47. The first end 14 of the compression seal 10 is then placed into the body 40 so that the resiliently deformable element 22 is located adjacent the free end 54 of the insert 42 and the sealing surface 20 of the compression seal 10 is adjacent the free end of the body 40. The compression nut 44 is then positioned over the bulbous section 18 of the compression seal 10 and screwed onto the body 40. Upon tightening of the nut 44, the lip 72 will apply an axial force to the compression seal 10 to urge the sealing surface 20 into contact with the free end of the body 40 and at the same time force the resiliently deformable element 22 to flex and compress against the free end 54 of the insert 42. The restoring force generated by the resiliently deformable element 22 in turn urges the insert 42 against the radial flange 47 of the body 40 to secure it thereto. In addition, the lip 72 applies a radial force to the collar 30 of the compression seal 10. Accordingly, the compression seal 10 is designed to provide a front seal between the sealing surface 20 and the body 40 and a rear seal between the collar 30 and the conduit 82 located in the fitting 90.

More, specifically, as shown in FIG. 7B, when the compression nut 44 is tightened such that the lip 72 applies an axial force to the compression seal 10 to urge the sealing surface 20 into contact with the free end of the body 40, the material of the seal 10 surrounding the slots 24 is forced to deform into the spaces provided by the slots 24, causing the resiliently deformable element 22 to compress and it is the resilience of this material that ensures that the compression nut 44 transmits force via the seal 10 to the insert 42 to force the insert 42 against the radial flange 47 of the body 40. At the same time, the lip 72 applies a radial force through the second end 16 to the collar 30 of the compression seal 10 such that the collar 30 engages in a flat sealing relationship with the plastic sheath 86.

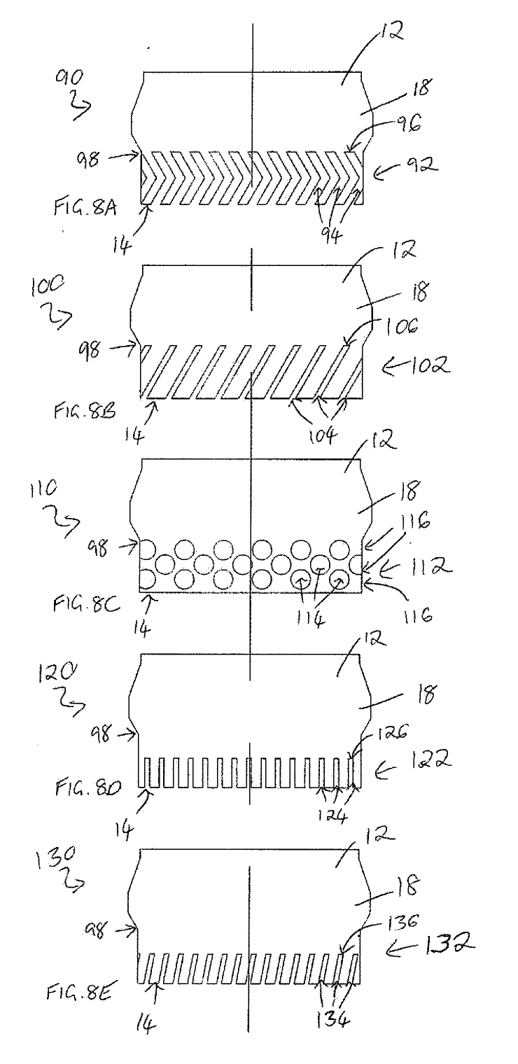

FIGS. 8A through 8E show compression seals according to further embodiments of the present invention wherein each seal comprises a different resiliently deformable element. The compression seals shown in FIG. 8A through 8E are identical to the compression seal 10 shown in FIGS. 1 and 4 except for the resiliently deformable element and so like reference numerals will be used, where appropriate.

FIG. 8A shows a compression seal 90 having a resiliently deformable element 92 comprising a series of axially extending V-shaped slots 94. The slots 94 are open at the first end 14 of the trunk 12 and terminate in a closed end 96 at a first edge 98 of the bulbous section 18. It will be understood that the first edge 98 of the bulbous section 18 is the edge closest to the first end 14.

FIG. 8B shows a compression seal 100 having a resiliently deformable element 102 comprising a series of sloped slots 104. The slots 104 are open at the first end 14 of the trunk 12 and terminate in a closed end 106 at the first edge 98 (as defined above in relation to FIG. 8A) of the bulbous section 18. It will be noted that the slots 104 are sloped such that they extend in a direction which is not parallel or perpendicular to the first end 14.

FIG. 8C shows a compression seal 110 having a resiliently deformable element 112 comprising a series of circular holes 114 disposed in three axially spaced rings 116. The middle one of the three rings 116 is radially offset with respect to the first and third rings 116 such that the holes 114 in the middle ring 116 are axially disposed adjacent material provided between the holes 114 in the first and third rings 116. In addition, the holes 114 of the middle ring 116 radially overlap in part with the holes 114 in each of the first and third rings 116. The rings 116 extend from adjacent the first end 14 of the trunk 12 to adjacent the first edge 98 (as defined above in relation to FIG. 8A) of the bulbous section 18.

FIG. 8D shows a compression seal 120 having a resiliently deformable element 122 comprising a series of slots 124. The slots 124 are open at the first end 14 of the trunk 12 and extend perpendicularly therefrom to terminate in a closed end 126 part-way towards the first edge 98 (as defined above in relation to FIG. 8A) of the bulbous section 18.

FIG. 8E shows a compression seal 130 having a resiliently deformable element 132 comprising a series of sloped slots 134. The slots 134 are open at the first end 14 of the trunk 12 and extend in a sloped direction therefrom to terminate in a closed end 136 part-way towards the first edge 98 (as defined above in relation to FIG. 8A) of the bulbous section 18. As above, it will be noted that the slots 134 are sloped such that they extend in a direction which is not parallel or perpendicular to the first end 14.

It will be understood that each of the compression seals described above in relation to FIGS. 8A through 8E function in the same way as the compression seal 10, when in use. Thus, they function in the same way as described in detail above in relation to FIGS. 7A and 7B.

It will be appreciated by persons skilled in the art that various modifications may be made to the above embodiments without departing from the scope of the present invention. For example, whilst the above discussion has been primarily concerned with maintaining an electrical connection, the invention is equally applicable to other applications.

1. A compression seal for a conduit fitting comprising a body and an insert, the compression seal comprising:
an annular trunk having a first end, a second end and an outwardly bulbous section therebetween;
a sealing surface provided on an outer portion of said bulbous section; and
wherein a resiliently deformable element is provided at or adjacent the first end of the trunk.

2. The seal according to claim 1 wherein the resiliently deformable element comprises one or more slots or holes provided adjacent the first end of the trunk.

3. The seal according to claim 2 wherein the slots are fully enclosed by the material of the resiliently deformable element.

4. The seal according to claim 2 wherein the slots are part-annular and extend generally in an axial direction.

5. The seal according to claim 2 wherein the slots extend perpendicularly to the first end or are sloped thereto.

6. The seal according to claim 2 wherein two or more part-annular slots are provided at the same axial position so as to form a discontinuous ring of slots around the trunk.

7. The seal according to claim 6 wherein two or more discontinuous rings of slots are provided, each spaced axially from the other.

8. The seal according to claim 7 wherein each discontinuous ring of slots is arranged such that only a portion of each slot is axially aligned with a portion of an adjacent slot.

9. The seal according to claim 2 wherein a spiral slot is provided adjacent the first end of the trunk.

10. The seal according to claim 1 wherein the second end of the trunk is formed into a collar extending in an axial direction.

11. The seal according to claim 1 wherein an annular channel is provided in the inner surface of the compression seal, radially opposite to the outwardly bulbous section.

12. The seal according to claim 1 wherein the bulbous section is substantially in the form of a half hexagon when viewed in cross-section.

13. A fitting comprising a body, an insert and the compression seal according to claim 1.

14. The fitting according to claim 13 wherein the body comprises a first hollow cylinder having a first diameter and a second hollow cylinder having a second diameter, the first and second diameters being different such that a radial flange is provided therebetween.

15. The fitting according to claim 14 wherein the insert comprises a radially flat annular base sized to fit within one of the first or second cylinders of the body and to abut the radial flange thereof.

16. The fitting according to claim 15 wherein a hollow outer cylindrical shaft extends from the outer circumference of the base and comprises an axially aligned ribbed outer surface.

17. The fitting according to claim 16 wherein a free end of the outer cylindrical shaft is arranged to mate with the first end of the compression seal, when in use.

18. The fitting according to claim 16 wherein a hollow inner cylindrical shaft extends from the inner circumference of the base in the same direction as the outer cylindrical shaft and a single spiral projection is provided on the outer surface of the inner cylindrical shaft, towards the free end thereof.

19. The fitting according to claim 16 further comprising a compression nut configured for screw-fit engagement with the larger of the first or second cylinders of the body and wherein the end of the compression nut furthest from the body, when in use, is provided with an inwardly extending radial lip.

20. An assembly comprising a first conduit, a second conduit and the fitting according to claim 13 therebetween.
